(19) United States
(12) Patent Application Publication
(10) Pub. No.: US 2018/0050465 A1
(43) Pub. Date: Feb. 22, 2018

(54) CARBIDE INSERT MECHANICAL CLAMP FEED ROLLER

(71) Applicant: Russell L. Martin, Peshtigo, WI (US)

(72) Inventor: Russell L. Martin, Peshtigo, WI (US)

(73) Assignee: Great Lakes Custom Tool Mfg., Inc., Peshtigo, WI (US)

(21) Appl. No.: 15/241,663

(22) Filed: Aug. 19, 2016

(51) Int. Cl. B27B 31/00; B27B 25/00

(52) U.S. Cl. CPC B27B 31/003; B27B 25/00

(57) ABSTRACT

A feed roller is provided with feed roller head having a helical carbide gripping inserts. The gripping inserts extend along a helical path and are configured to grip and shift a work piece in a predetermined direction. The gripping inserts are secured to the feed roller body in a helical slot formed between a wall of the feed roller body and a plurality of clamping wedges. The clamping wedge facilitates locking and securing the gripping insert to the feed roller body in a radial direction in response to centrifugal forces created as the feed roller head rotates.

### FIELD OF THE INVENTION

This invention generally relates to a feed roller head and more specifically to a system and method for using a feed roller head to shift a work piece in a predetermined direction.

### BACKGROUND OF THE INVENTION

Typically, saw-teeth are required on the feed roller heads used in lumber mills in order that cants (or squared-off logs which have two opposed planar surfaces) may be securely gripped for accurately positioned feeding into a band saw or saw cluster.

At present, in commercial operations, the saw-teeth are available in short strips of the various lengths. One or more strip lengths, depending on the length of the feed roller head, are forced into a tight-fitting groove in the body of the feed roller head by hammering or pinch clamping. The saw-teeth become blunted and ineffective after about six months to a year's use and require replacement.

In order to replace the worn saw-teeth, it is necessary to first remove the feed roller head from the machine. The technique for removing the inserts involves manually (or less commonly, pneumatically) chiseling the inserts out of the groove. Manual chipping is slow and inflicts damage to the groove. Pneumatic removal poses potential hazards to the operators due to the danger of flying metal fragments. Replacement of an insert can only be conducted by the conventional manual technique about three times before excessive damage to the groove has resulted. Usually at this point the saw-teeth strips are welded into the groove, for a final usage and upon dulling of these welded teeth the whole feed roller head usually is discarded.

Feed roller heads having are well known, as exemplified, by U.S. Pat. App. No. 2015/0210474 teachings a tapered feed roller head; U.S. Pat. No. 4,509,574 that teaches an improvement in a debarking machine wherein feed roll spikes having plus-shaped cutting edges are provided; and U.S. Pat. No. 4,385,650, which describes an improved feed roller head for logs that has a plurality of radially extending trapezoidally shaped pyramids spaced circumferentially about the surface.

However, there still exists the need for a feed roller head having a gripping insert that is more durable, can be easily replaced to extend the usable life of the feed roller head, and replacement of the gripping insert is speedier and less labor intensive. The invention provides such a feed roller head. These and other advantages of the invention, as well as additional inventive features, will be apparent from the description of the invention provided herein.

### BRIEF SUMMARY OF THE INVENTION

In one aspect the invention provides a system for working on a work piece having a feed roller having a feed roller head. The feed roller head having a body including at least one gripping insert and at least one clamping element for clamping at least one gripping insert to the body of the feed roller. The feed roller head having a rotary axis. The feed roller is capable of shifting a workpiece in a predetermined direction when the at least one gripping insert contacts the work piece and the feed roller head is rotated about its rotary axis. The system further comprising a machining system downstream of said feed roller having a machining element capable of working on the work piece being fed in the predetermined direction by the feed roller head.

In another aspect the system has a helical gripping insert is made from carbide.

According to another aspect the machining element of the system is a cutting tool capable of cutting the work piece.

According to another aspect the feed roller head in the system can shift the work piece in the predetermined direction between 50 feet per minute and 400 feet per minute.

In yet another aspect, the feed roller head in the system rotates about the rotary axis between 1 and 100 rotations per minute.

According to one aspect the work piece processed in the system is a piece of wood.

In another aspect the clamping element of the feed roller head used in the system is coupled to the feed roller head by a compound screw.

In yet another aspect a feed roller head having a feed roller body configured to rotate in a predetermined direction about an axis of rotation. The feed roller head having at least on clamp arranged to provide support along a helical path. The feed roller head having a helical slot formed by the combination of the feed roller body and the at least one clamp along the helical path. The slot having a front wall formed by the feed roller body and a rear wall formed by the at least one clamp and the front wall is forward of the rear wall relative to the predetermined direction. The feed roller head having a helical gripping insert clamped into the slot by the at least one clamp.

According to another aspect the feed roller head has a helical gripping insert is made from carbide.

In yet another aspect the clamp comprises a plurality of clamping wedges residing in a helical channel defined by the feed roller body.

According to one aspect the multiple helical channels clamping wedges and helical gripping inserts are arranged at different angular positions about the axis of rotation.

In yet another aspect a second helical gripping insert is clamped into a second slot by the clamp.

According to another aspect the second slot is formed by a combination of the feed roller body and the at least one clamp along the helical path, the second slot having a rear wall formed by the feed roller body and a front wall formed by the at least one clamp, wherein the front wall is forward of the rear wall relative to the predetermined direction.

In yet another aspect, the body of the feed roller head has a connection portion to connect with a feed roller of a machining system.

According to yet still another aspect, the connection portion of the feed roller head is a through bore.

According to yet another aspect a method including powering a feed roller causing at least one feed roller head to rotate about its rotary axis. Placing the work piece on the feed roller such that it comes into contact with at least one gripping insert coupled to the feed roller head. Shifting the work piece a predetermined direction toward the machining system through contact with the gripping insert. Releasing the work piece from the gripping insert of the feed roller head such that the work piece shifts the predetermined direction and is completely received by the machining system. Processing the work piece through the machining system.

According to yet another aspect a method of advancing sheet material including engaging the sheet material with a feed roller. The feed roller having a feed roller head having a body. The feed roller head includes at least one gripping insert and at least one clamping element for clamping the at least one gripping insert to the body of the feed roller. Rotating said feed roller head about a rotary axis and feeding the sheet material in a predetermined direction with the at least one gripping insert contacting the work piece during said rotating.

According to another aspect a method where the sheet material is a wood material, and wherein the gripping insert indents the wood material leaving an indentation.

According to yet another aspect a method where the indentation is between 0.1 millimeter and 2 millimeter deep.

In yet another aspect a method including machining a layer from the wood material and removing the indentation during machining.

According to another aspect a method where the machining comprises utilizing a rotating cutter having a plurality of knives disposed about a cutter body, and during an operation mode, the feed roller is operated at a rotational speed of between 1 and 100 rpm; and wherein the rotating cutter is operated at a rotational speed of between 3,000 rpm and 12,000 rpm.

According to another aspect a plurality of gripping inserts and a plurality of the clamping elements are provided at a regular angular spacing around the body of the feed roller. The regular angular spacing is provided such that at least one of the gripping inserts is in contact with the sheet material at all times to ensure continuous feeding of the sheet material.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an isometric view of a feed roller head having a gripping insert having a helical shape and made of carbide in accordance with a preferred embodiment of the present invention;

FIGS. 2 and 3 are side and end views of the feed roller head shown in FIG. 1, respectively;

FIG. 4 is an enlarged partial end view of the feed roller head shown in FIG. 1, illustrating the securement of the gripping insert;

FIGS. 5 and 6 are side and end views of the gripping insert for use in the feed roller head shown in FIG. 1, respectively;

FIG. 7 is a cross-section of the gripping insert shown in FIGS. 5 and 6;

FIG. 8 is an isometric view of one of the clamping wedges as used in the feed roller illustrated in FIG. 1;

FIGS. 9, 10, and 11 are plane, side and end views of the clamping wedge shown in FIG. 8, respectively, with hidden lines showing threaded hole and profile details;

FIG. 12 is a cross-sectional illustration of the feed roller head detail shown in FIG. 4;

FIG. 13 is a perspective side-view of a system for shifting a work piece incorporating the feed roller head illustrated in FIG. 1 and a machining system to process the work piece;

FIG. 14 is a partial perspective view of the feed roller head showing an exploded view of one set of gripping inserts, clamping wedges, and compound screws removed from a helical channel of the feed roller head.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

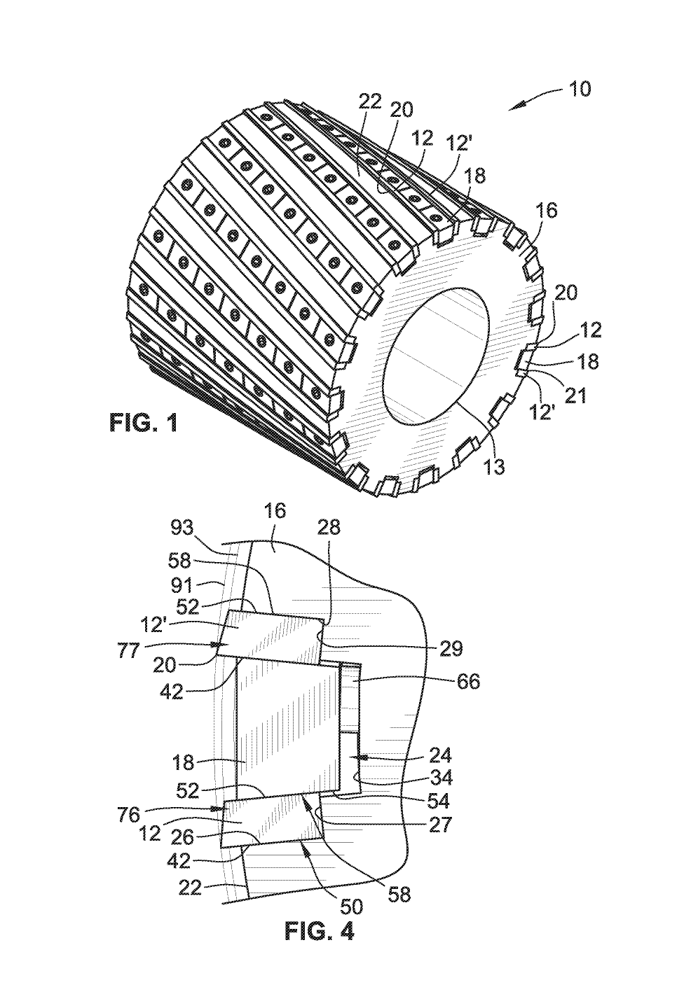

Referring to FIG. 1, a feed roller head 10, having a first helically shaped gripping insert 12 and a second helically shaped gripping insert 12′ in accordance with one aspect of the present invention is illustrated. The feed roller head 10 is used to grip a work piece and then shift the work piece a predetermined distance and direction.

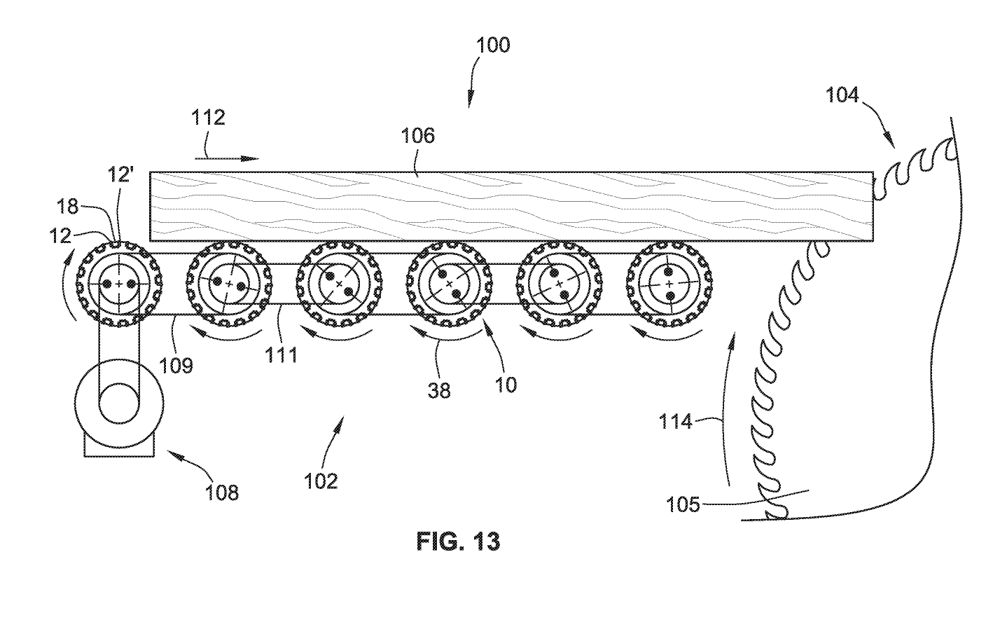

The feed roller 102 has a motor 108 (see FIG. 13) that drives the feed roller head 10 about an axis of rotation 14 (see FIG. 3) in a predetermined direction 38. The feed roller head 10 has a connection portion 13. The connection portion 13 provides a means for the feed roller head 10 to connect to a feed roller 102 of a machining system 100 (see FIG. 13). In a preferred embodiment, the connection portion 13 is a through bore that extends axially through the body 16 of the feed roller head 10 along the axis of rotation 14 (see FIG. 3). However, as will be understood by one having ordinary skill in the art, the connection portion 13 of the feed roller head 10 is not limited to being a through bore and the feed roller head 10 may connect with the feed roller 102 by any means generally known in the art.

As illustrated, the feed roller head 10 is configured to rotate in a single predetermined direction 38 about the axis of rotation 14. The direction of rotation for the disclosed embodiment, as viewed in FIG. 3 and indicated by arrow 38, is counter-clockwise about the axis of rotation 14.

As shown in FIG. 1, the feed roller head 10 of the present invention generally includes a feed roller body 16, gripping inserts 12, 12′ and a plurality of clamping wedges 18. The gripping inserts 12, 12′ provide gripping edges 20 for the feed roller head 10 and are secured to the feed roller body 16 by a plurality of clamping wedges 18. In a preferred embodiment, the gripping inserts 12, 12′ are manufactured from carbide and the feed roller body 16 and clamping wedges 18 are manufactured from steel. The gripping inserts 12, 12′ are wedged between a portion of the feed roller body 16 and the clamping wedges 18. Embodiments of the feed roller head 10 may include any number of gripping inserts 12, 12′, but typically more than one, and typically with a balanced orientation (e.g. the gripping inserts 12, 12′ being equally spaced apart at angular intervals). Further, typically embodiments of the feed roller head 10 will space the gripping inserts 12, 12′ such that at least one of the gripping insert 12, 12′ is in contact with the work piece until the work piece has been shifted off of the feed roller head 10 in the predetermined direction 112 (see FIG. 13).

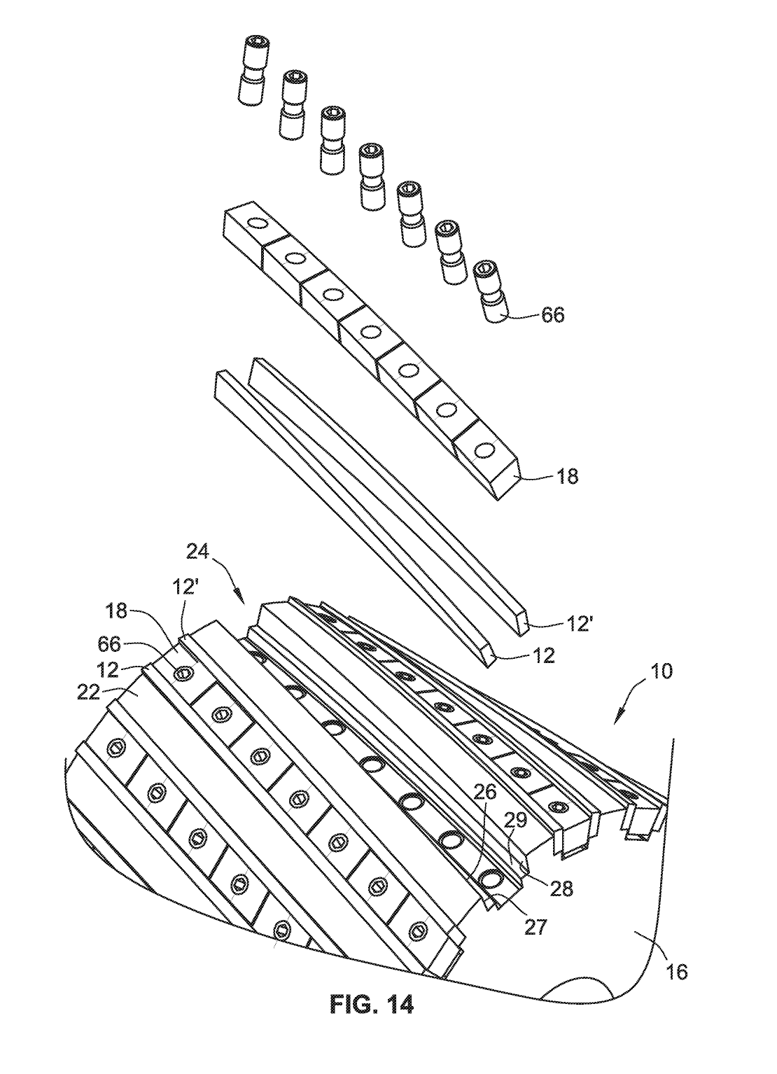

As is best illustrated with reference to FIGS. 1-4, 12, and 14 the outer periphery 22 of the feed roller body 16 includes helical channels generally indicated at 24. The channels 24 provide a first area/void for receiving the clamping wedges 18 and the gripping inserts 12, 12′. The first area/void of the channel 24 includes a leading wall 26 and a trailing wall 28 extending radially inward. The leading wall 26 is forward of the trailing wall 28 relative to the predetermined direction of rotation 38 of the feed roller head 10. In addition, the leading wall 26 extends along a helical path that is substantially parallel to a helical path of the trailing wall 28.

Further, the channels 24 provide a second area/void for partially receiving the clamping wedges 18. The second area/void of the channel 24 includes a second leading wall 33 and a second trailing wall 35 extending radially inward. The second leading wall 33 is forward of the second trailing wall 35 relative to the predetermined direction of rotation of the feed roller head. In addition, the second leading wall 33 extends along a helical path that is substantially parallel to a helical path of the second trailing wall 35.

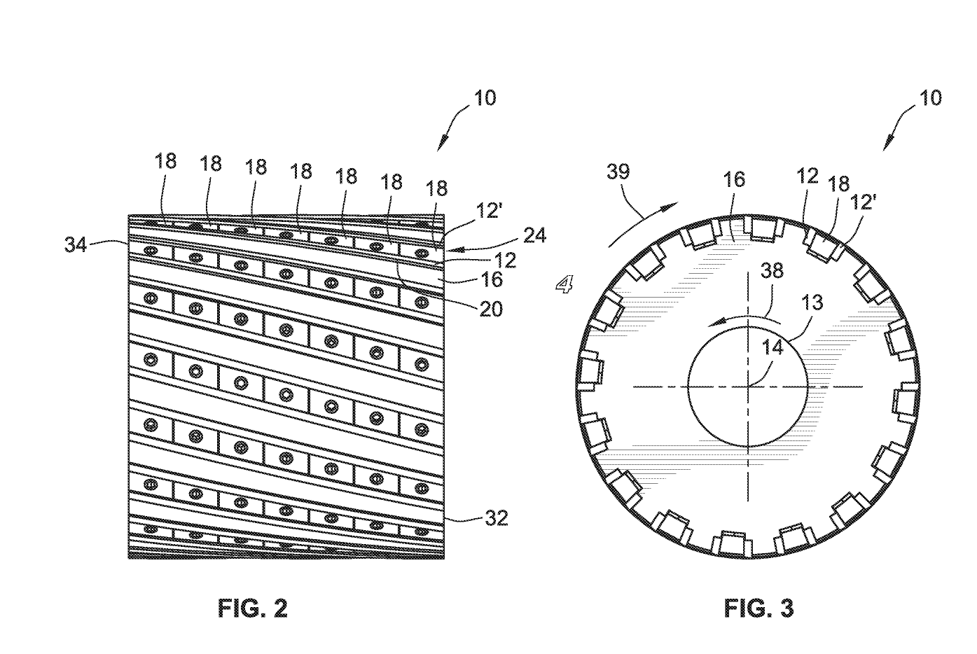

As shown in FIG. 2, the helical channels 24 extend between opposed axial ends 32 and 34 of the feed roller body 16. The helical channels 24 also extend angularly about the axis of rotation 14 of the feed roller head 10. The helical shape is preferably configured with respect to the predetermined direction of rotation 38. Specifically, the helical channels 24 preferably coil about the axis 14 in a direction opposite the predetermined direction of rotation 38. In the illustrated embodiment, the feed roller head 10 is designed to rotate counter-clockwise (see arrow 38 in FIG. 3). As a result, the helical channels 24 extend angularly in the opposite clockwise direction, indicated by arrow 39, when moving in an axial direction from the distal 32 end to the connection end 34. Conversely, if the feed roller head 10 is designed to rotate clockwise, when viewed up the axis of rotation 14 from the distal end 32 to connection end 34, the helical channels 24 would preferably extend angularly in the counter-clockwise direction.

At least one clamp and preferably multiple clamps in the form of clamping wedges 18 secure the gripping inserts 12, 12′ within the helical channel 24. The gripping inserts 12, 12′ have a helical shape and extend along a helical path. In a preferred embodiment, the gripping inserts 12, 12′ are manufactured from carbide. As best illustrated with reference to FIGS. 1 and 2, the helical path and contour of the gripping inserts 12, 12′ are the same as the helical path and contour of the helical channel 24.

The gripping insert 12 is secured and locked to the feed roller body 16 by being wedged in a first slot 76. In the illustrated embodiment the first slot 76 is defined between the leading wall 26 of the helical channel 24 and the front face/wall 54 of the clamping wedges 18 collectively. The gripping inset 12′ is secured and locked to the feed roller body 16 by being wedged in a second slot 77 that is defined between the trailing wall 28 of the helical channel 24 and the rear face/wall 56 of the clamping wedges 18 collectively.

The first receiving slot 76 and the second receiving slot 77 are wider radially inward towards the axis of rotation 14. Furthermore, the width of a radially outer portion of the first receiving slot 76 and the second receiving slot 77 are narrower than the width of the bottom 62 of the respective gripping inserts 12, 12′ inserted in the first and second receiving slots 76,77. By having the gripping inserts 12, 12′ with a wider bottom 62 than a radially outer portion of their respective first receiving slot 76 and second receiving slot 77, the clamping wedges 18 act to positively lock the gripping inserts 12, 12′ in the radial direction. This inward positive locking arrangement opposes centrifugal forces applied to the gripping inserts 12, 12′ resulting from high speed rotation of the feed roller head 10 during use.

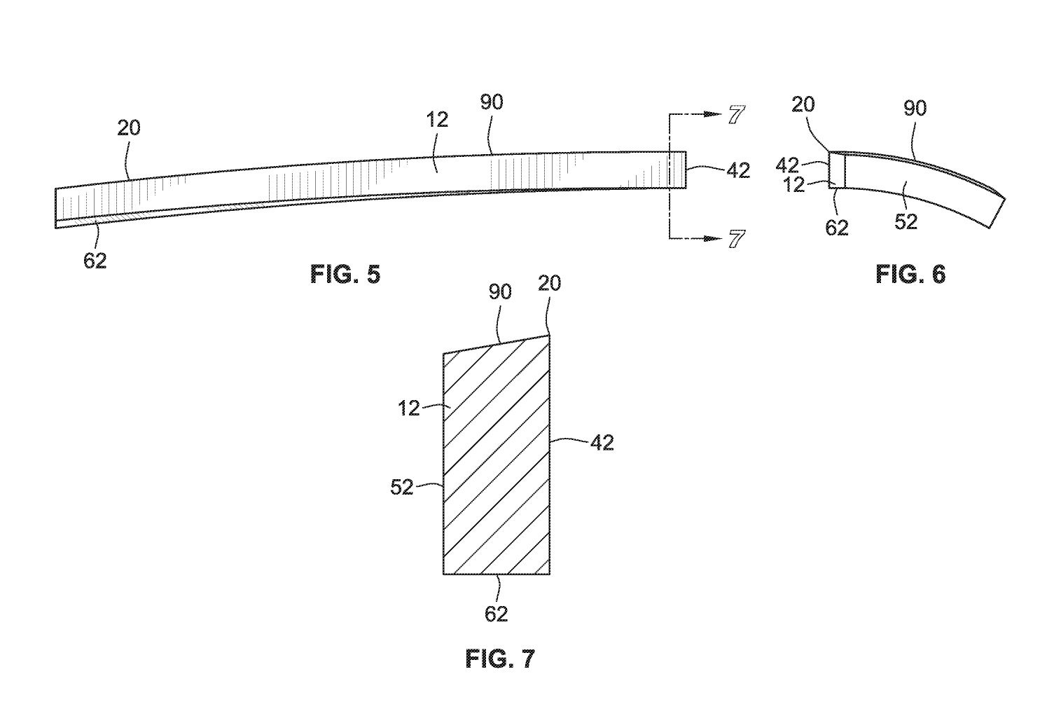

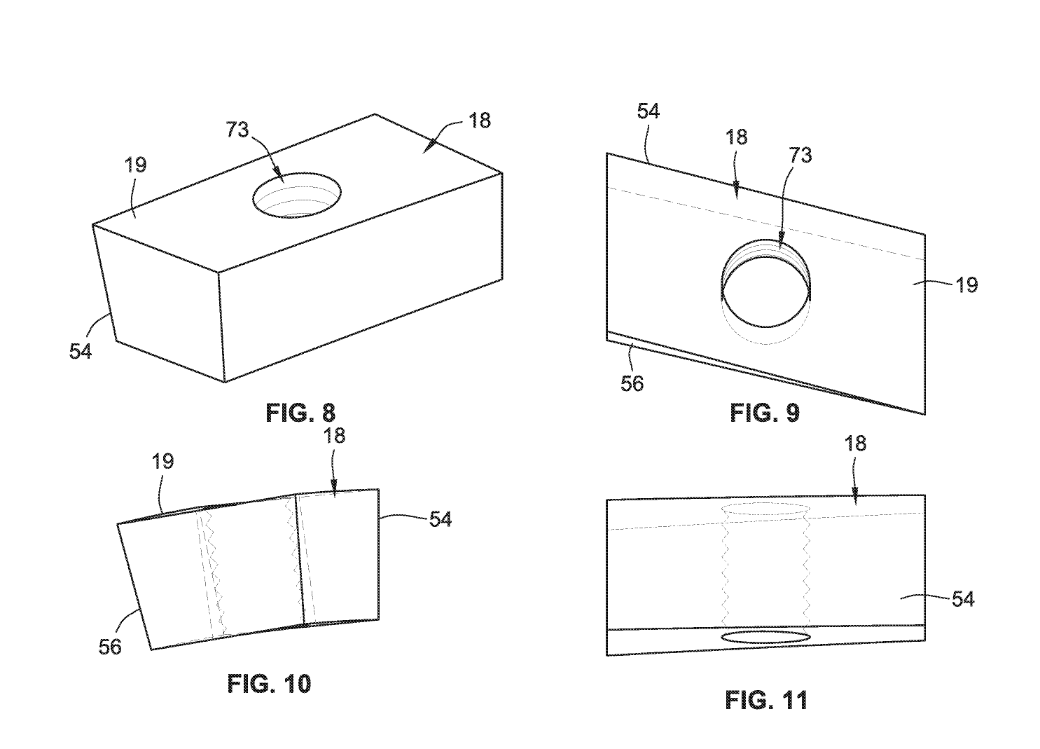

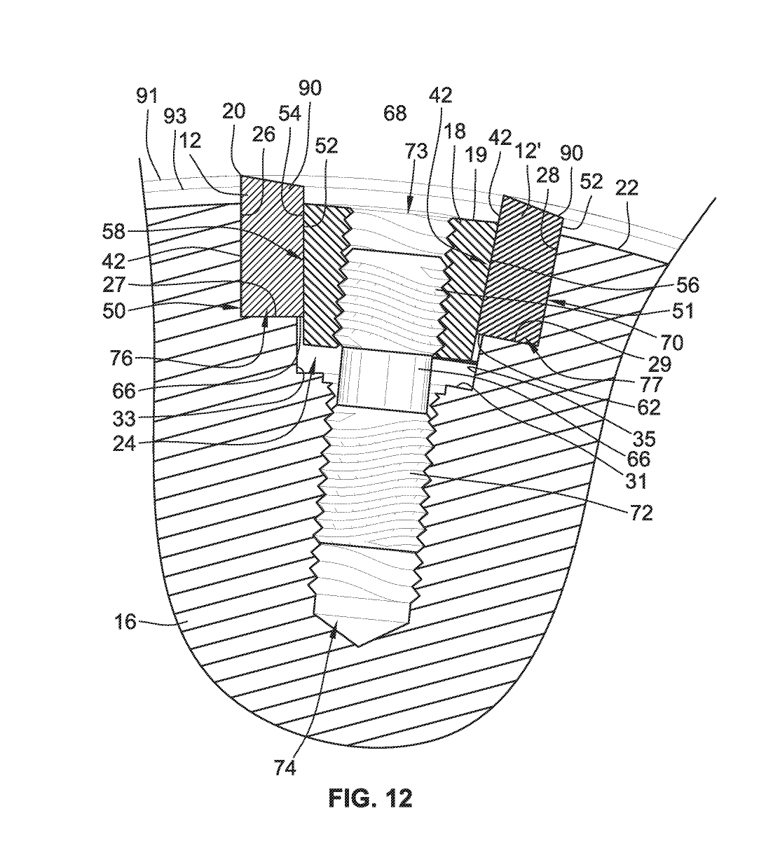

Best illustrated with reference to FIGS. 5 and 7, the leading face 42 of the first gripping inserts 12, 12′ have a top edge 90, which provides the gripping edge 20. As shown in FIG. 4, the leading face 42 of the first gripping insert 12 abuts with the leading wall 26 of the helical channel 24 at interface 50. A trailing face 52 (see FIGS. 6 and 7) of the first gripping insert 12 abuts with a front face 54 of the clamping wedge 18 at interface 58 (see FIGS. 4 and 12). Likewise, the leading face 42 of the second gripping insert 12′ abuts the trailing face 56 of the clamping wedge 18 at interface 59 and the trailing face 52 of the second gripping insert 12′ abuts the trailing wall 28 of the helical channel 24 at interface 51.

In accordance with an aspect of the present invention, the clamping wedges 18 are located between the gripping inserts 12, 12′. Further, in accordance with another aspect of the present invention, the top surface 19 of the clamping wedge 18 is located radially inward of the top surface 90 of the gripping inserts 12, 12′ relative to the axis of rotation 14 of the feed roller head 10. Importantly, this helps to protect the clamping wedges 18 by preventing the top surface 19 of the clamping wedges 18 from making unnecessary contact with the work piece that is being shifted, which can lead to wearing of the clamping wedges 18.

Each of the clamping wedges 18 are threadedly secured to the feed roller body 16 by a fastener that may take the form of a compound screw 66, as illustrated in FIG. 12. The compound screw 66 includes a tool engagement socket 68, illustrated by dashed lines, for engaging the compound screw 66. For example, the tool engagement socket 68 may be a hex socket for receipt of and engagement with an Allen wrench (not shown). The compound screw 66 is a screw that has both a portion of left handed threads 70 and a portion of right handed threads 72 about the same axis of rotation. The left handed threads 70 threadedly engage an internally threaded bore 73 of the clamping wedge 18, and the right handed threads 72 engage an internally threaded bore 74 of the feed roller body 16. Thus, as the compound screw 66 is turned, it concurrently threads into or out of both the clamping wedge 18 and the feed roller body 16.

As the compound screw 66 is concurrently threaded into the clamping wedge 18 along a bottom surface 34 of the helical channel 24 of the feed roller body 16, the clamping wedge 18 is tightened, and specifically, drawn radially inward and towards the feed roller body 16 and into the helical channel 24. The clamping wedge 18 in combination with the helical channel 24 form the first receiving slot 76 between the leading wall 26 of the helical channel 24 and the front face 54 of the clamping wedge 18 where the gripping insert 12 can at least partially rest on bottom surface 27 of the helical channel 24. Likewise, the clamping wedge 18 in combination with the helical channel 24 form a second receiving slot 77 between the trailing wall 28 of the helical channel 24 and the rear face 56 of the clamping wedge 18 where the gripping insert 12′ can at least partially rest on bottom surface 29 of the helical channel 24.

The first receiving slot 76 and the second receiving slot 77 are helical having the same helical shape and contour as the helical channel 24 and the gripping insert 12. With the clamping wedges 18 aligned sided by side and secured to the feed roller body 16 within the helical channel 24, as illustrated in FIGS. 1 and 2, the first receiving slot 76 and the second receiving slot 77 extend between opposed ends 32 and 34 of the feed roller body 16. To establish the helical path, each clamping wedge 18 is partially angularly offset from one another in the angular direction 39 of the helical path about axis of rotation 14. Furthermore, the leading faces 54 of the clamping wedges 18 that provide support for the gripping insert 12 are configured such that there is a smooth transition from one clamping wedge 18 to the next and the trailing face 52, and consequently, the gripping insert 12, is fully supported by the clamping wedges 18 collectively. Likewise, the trailing faces 56 of the clamping wedges 18 that provide support for the gripping insert 12′ are configured such that there is a smooth transition from one clamping wedge 18 to the next and the leading face 42, and consequently, the gripping insert 12′, is fully supported by the clamping wedges 18 collectively.

The leading wall 26 of the helical channel 24 and the leading face 54 of the clamping wedge 18 cooperate and co-act to secure the gripping insert 12 illustrated in FIG. 7. Likewise, the trailing wall 28 of the helical channel 24 and the trailing face 56 of the clamping wedge cooperate and co-act to secure the gripping insert 12′.

During assembly, the clamping wedge 18 is tightened down causing it to wedge between the trailing face 52 of the first gripping insert 12 and the leading face 42 of the second gripping insert 12′. As the clamping wedge is wedged against the trailing face 52 of the first gripping insert 12 it imparts a tangential load on the gripping insert 12 that presses the leading face 42 of the gripping insert 12 against the leading wall 26 of the helical channel 23. Likewise, as the clamping wedge 18 is wedged against the leading face 42 of the second gripping insert 12′ it imparts a tangential load on the second gripping insert 12′ that presses the trailing face 52 of the second gripping insert against the trailing wall 28 of the helical channel 24. The tangential load applied to the gripping inserts 12, 12′ further secures the gripping inserts 12, 12′ to the feed roller body 16.

When the gripping inserts 12, 12′ are clamped to the feed roller body 16, the gripping inserts 12, 12′ extends radially beyond a portion of the outer periphery 22 of the feed roller body 16, as shown in FIG. 4. This ensures that both the outermost radial path 91 of the gripping inserts 12, 12′ and the innermost radial path 93 of the gripping inserts 12, 12′ are able to make strong contact with the work piece to shift the work piece in the predetermined direction 112, while also preventing the clamping wedges 18 from making inadvertent contact with the work piece, which could cause damage to the clamping wedges 18 or cause the clamping wedges 18 to loosen.

As best illustrated in FIGS. 4 and 7, the gripping insert 12 has a tapered outer peripheral surface 90 to better define the gripping edge 20 for engagement with the work piece. By having the outer surface 90 canted away from the gripping edge 20 from an outermost radial path 90 to an inner most radial path 93 of the outer surface 90, relative to the axis of rotation 15, it allows the gripping edge 20 to rotate about the outermost radial path 91 of the assembled feed roller head 10. The radially inward tapering of the outer peripheral surface 90 from the outermost radial path 91 to the innermost radial path 93 also acts help the gripping inserts 12, 12′ to make strong contact with the work piece while at the same time allowing the work piece to release from the gripping inserts 12, 12 after the gripping inserts 12, 12′ has shifted the work piece in the predetermined direction 112.

Turning to FIG. 13, a machining system 100 employs a feed roller 102 using feed roller heads 10, to shift a piece of lumber or work piece 106, in a predetermined direction 112. The feed roller heads 10 are coupled to the feed roller 102 via the connection portion 13 of the feed roller heads 10 (see FIGS. 1 and 3). The feed roller heads 10 can rotate about their axis of rotation 14 (see FIG. 3) in a predetermined direction 38 that correspond with the predetermined direction 112 that the piece of lumber or work piece 106 is to be shifted.

In use, the feed roller heads 10 rotate about their axis of rotation 14 (see FIG. 3) in the predetermined direction 38. The feed roller heads 10 then contact the piece of lumber or work piece 106 with their gripping inserts 12, 12′ that shift the piece of lumber or work piece 106 in the predetermined direction 112. The feed roller heads 10 will continue to rotate in the predetermined direction 38 and the gripping inserts 12, 12′ will continue to contact the piece of lumber or work piece 106 causing it to shift in the predetermined direction 112 until the piece of lumber or work piece 106 is fully inserted into the processing system 104.

In the illustrated embodiment, the processing system 104 consists of a cutting tool 105, which can be for example a band saw or cluster saw. The feed roller 102 has a motor 108 and belts 109 and 111 to rotate the feed roller heads 10 in a predetermined direction 38 that correspond with the predetermined direction 112 that the piece of lumber or work piece 106 needs to be shifted.

Further, it should be noted that some processing systems 104 require the feed roller 102 to shift the work piece in the predetermined direction 112 with sufficient force to drive the work piece through the processing system 104, such as for example, when a feed roller head 10 is required to shift a piece of lumber or work piece 106 in a predetermined direction 112 as the piece of lumber or work piece 106 is ripped by a cutting tool 105, such as a band saw or cluster saw.

According to one embodiment, it is envisioned that the feed roller head 10 can rotate between 1 and 100 rotations per minute.

According to another embodiment, it is envisioned that the feed roller head 10 can shift a work piece in a predetermined direction 112 between 50 and 400 feet per minute.

According to another embodiment, it is envisions that the gripping inserts 12,12′ can indent a piece of lumber or work piece 106, such as a sheet material, such that the piece of lumber or work piece 106 is left with an indentation.

In yet another embodiment, it is envisioned that the indentation left in the lumber or work piece 106, such as a sheet material, by the gripping inserts 12,12′ can be between 0.1 millimeter and 2 millimeter deep.

In yet another embodiment, it is envisioned the processing system 104 can machine a layer from the piece of lumber or work piece 106, such as a sheet material, to an indentation made in the piece of lumber or work piece 106, such as a sheet material, by the gripping inserts 12,12′ during machining.

According to another embodiment the processing system 104 utilizes a cutting tool 105, such as a rotating cutter having a plurality of knives disposed about the rotating cutter.

According to another embodiment, it is envisioned that the cutting tool 105, such as a rotating cutter having a plurality of knives disposed about the rotating cutter, can operate at a rotational speed of between 3,000 rpm and 12,000 rpm.

According to another embodiment, it is envisioned that in operation the feed roller head 10 can have a rotational speed of between 1 and 100 rpm.

According to another embodiment, it is envisioned that gripping inserts 12,12′ and clamping elements, such as clamping wedges 18, are provided at a regular angular spacing around the body 16 of the feed roller head 10. The regular angular spacing of the gripping inserts 12,12′ and the clamping elements, such as clamping wedges 18, allow for at least one of the gripping inserts 12,12′ to be in contact with a piece of lumber or work piece 106, such as a sheet material, at all times to ensure continuous feeding of the piece of lumber or work piece 106, such as a sheet material.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context

What is claimed is:

1. A system for working on a work piece comprising:
a feed roller having a feed roller head having a body;
the feed roller head includes at least one gripping insert and at least one clamping element for clamping the at least one gripping insert to the body of the feed roller;
wherein said feed roller head has a rotary axis;
wherein said feed roller is capable of shifting a workpiece in a predetermined direction when the at least one gripping insert contacts the work piece and the feed roller head is rotated about its rotary axis;
a machining system downstream of said feed roller having a machining element capable of working on the work piece being fed in the predetermined direction by the feed roller head.

2. The system of claim 1, wherein the helical gripping insert is made from carbide.

3. The system of claim 1, the machining element is a cutting tool capable of cutting the work piece.

4. The system of claim 1, wherein the feed roller head can shift the work piece in the predetermined direction between 50 feet per minute and 400 feet per minute.

5. The system of claim 1, wherein the feed roller head rotates about the rotary axis between 1 and 100 rotations per minute.

6. The system of claim 1, wherein the work piece is a piece of wood.

7. The system of claim 1, wherein the clamping element is coupled to the feed roller head by a compound screw.

8. A feed roller head comprising:
a feed roller body configured to rotate in a predetermined direction about an axis of rotation;
at least on clamp arranged to provide support along a helical path,
a helical slot formed by the combination of the feed roller body and the at least one clamp along the helical path, the slot having a front wall formed by the feed roller body and a rear wall formed by the at least one clamp, wherein the front wall is forward of the rear wall relative to the predetermined direction; and
a helical gripping insert clamped into the slot by the at least one clamp.

9. The feed roller head of claim 8, wherein the helical gripping insert is made from carbide.

10. The feed roller head of claim 8, wherein the at least one clamp comprises a plurality of clamping wedges residing in a helical channel defined by the feed roller body.

11. The feed roller head of claim 10, wherein the multiple helical channels clamping wedges and helical gripping inserts are arranged at different angular positions about the axis of rotation.

12. The feed roller head of claim 8, wherein a second helical gripping insert is clamped into a second slot by the clamp.

13. The feed roller head of claim 12, wherein the second slot is formed by the combination of the feed roller body and the at least one clamp along the helical path, the second slot having a rear wall formed by the feed roller body and a front wall formed by the at least one clamp, wherein the front wall is forward of the rear wall relative to the predetermined direction.

14. The feed roller head of claim 8, wherein the body has a connection portion to connect with a feed roller of a machining system.

15. The feed roller head of claim 14, wherein the connection portion is a through bore.

16. A method using the system of claim 1, comprising:
powering a feed roller causing at least one feed roller head to rotate about its rotary axis.

17. The method of claim 16, further comprising:
placing the work piece on the feed roller such that it comes into contact with at least one gripping insert coupled to the feed roller head.

18. The method of claim 17, further comprising:
shifting the work piece a predetermined direction toward the machining system through contact with the gripping insert.

19. The method of claim 18, further comprising:
releasing the work piece from the gripping insert of the feed roller head such that the work piece shifts the predetermined direction and is completely received by the machining system.

20. The method of claim 19, further comprising:
processing the work piece through the machining system.

21. A method of advancing sheet material, comprising:
engaging the sheet material with a feed roller, the feed roller having a feed roller head having a body; the feed roller head includes at least one gripping insert and at least one clamping element for clamping the at least one gripping insert to the body of the feed roller;
rotating said feed roller head about a rotary axis;
feeding the sheet material in a predetermined direction with the at least one gripping insert contacting the work piece during said rotating.

22. The method of claim 21, wherein the sheet material is a wood material, and wherein the gripping insert indents the wood material leaving an indentation.

23. The method of claim 22, wherein the indentation is between 0.1 millimeter and 2 millimeter deep.

24. The method of claim 22, further comprising machining a layer from the wood material and removing the indentation during machining.

25. The method of claim 22, wherein the machining comprises utilizing a rotating cutter having a plurality of knives disposed about a cutter body, and wherein during an operation mode, the feed roller is operated at a rotational speed of between 1 and 100 rpm; and wherein the rotating cutter is operated at a rotational speed of between 3,000 rpm and 12,000 rpm.

26. The method of claim 21, wherein a plurality of the at least one gripping insert and a plurality of the at least one clamping element are provided at a regular angular spacing around the body of the feed roller, wherein the regular angular spacing is provided such that at least one of the plurality of the at least one gripping insert is in contact with the sheet material at all times to ensure continuous feeding of the sheet material.
